(19) United States
(12) Patent Application Publication
(10) Pub. No.: US 2024/0313985 A1
(43) Pub. Date: Sep. 19, 2024

(54) GENERATING A RESPONSE TO AN ATTESTATION CHALLENGE USING A PRIVATE KEY

(71) Applicant: Hewlett-Packard Development Company, L.P., Spring, TX (US)

(72) Inventors: Alberto SUCH VICENTE, Sant Cugat del Valles (ES); Helen BALINSKY, Bristol (GB)

(21) Appl. No.: 18/272,651

(22) PCT Filed: Jan. 29, 2021
(86) PCT No.: PCT/US2021/015705

§ 371 Date: Jul. 17, 2023

(51) Int. Cl. H04L 9/32; G06F 3/12; H04L 9/08

(52) U.S. Cl. CPC H04L 9/3271; G06F 3/1222; G06F 3/1236; H04L 9/0869; H04L 9/3247

(57) ABSTRACT

A method comprises: receiving, at a secondary printer module, an attestation challenge generated by a primary printer module; deriving, from a set of executable instructions encoded on a non-transitory machine-readable storage medium of the secondary printer module, a private key: generating, from the attestation challenge and the private key, a response to the attestation challenge; and communicating the response to the primary printer module.

### BACKGROUND

Where separated computing systems interact with one another it may be desirable that one of the systems can make reliable statements about its configuration to the other system. This allows the other system to authorize further communication with the first system and permit certain computing processes to proceed.

Remote attestation allows a computing device to authenticate itself or the software running on the device by making statements about itself to another system, which can then verify those statements are accurate.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram of an example primary printer module and an example secondary printer module.

FIG. 2 is a flow chart of an example of first and second methods of remotely attesting a set of executable instructions encoded on a computing device.

FIG. 3 is a flow chart of an example method of generating a cryptographic asymmetric public/private key pair from a set of executable instructions.

FIG. 4 is a flow chart of an example of the first method of remotely attesting a set of executable instructions encoded on a computing device.

FIG. 5 is a flow chart of an example of the second method of remotely attesting a set of executable instructions encoded on a computing device.

FIG. 6 is a flow chart of an example method of generating a cryptographic asymmetric public/private key pair from a set of executable instructions.

FIG. 7 is a block diagram illustrating a non-transitory machine-readable storage medium according to one example.

FIG. 8 is a block diagram illustrating a non-transitory machine-readable storage medium according to another example.

### DETAILED DESCRIPTION

Where a computing device is to communicate and cooperate with a second remote, or structurally separate, computing device, there is a risk that the second computing device is not the device it purports to be or is not behaving as intended. For example, the second computing device may be a physical imposter or have been modified in some manner such that the second computing device behaves maliciously or compromises, in turn, the first computing device. In some cases, a computer program installed on the second device may be a counterfeit or may have been compromised by an attacker so that, from the perspective of the first device, the computer program appears to function as expected when, in fact, the computer program is performing abnormally.

To ensure the first device is interacting with a legitimate computer program, the computer program may be authenticated before any further cooperation between the first and second devices, or with the computer program installed on the second device, is permitted. In some instances, a measurement of the computer program present on the second device may be taken and exchanged with the first device. In some examples, additional data may be measured at the same time and included in the measured value. For instance, configuration settings, the current system state, or other determinations of how the system of the second device will behave may be included in the measured value or data. The value may be derived from the machine code stored on a memory of the second device, for example from a binary image of the stored computer program. The measured value can be compared within the first device with an expected value of the measurement and, if the values match, then the computer program is considered authentic. However, this method requires that the expected value is known by the first device so that the comparison can be made. This represents a security weakness because an attacker may be able to extract the expected value of the computer program. Additionally, the transmission of the measured value from the second device to the first device may be intercepted so that an attacker could extract the measured value. In such instances, an attacker could comprise the computer program, or replace it with an illegitimate version, which relays the expected value to the first device despite any actual measured value of the compromised or illegitimate computer program not meeting the expected value. In this way, the computer program running on the second device can act as though it is legitimate when, in fact, it is not.

In some cases, remote attestation of a computer program installed on a remote device can be performed with the aid of the hardware present in the remote device. In one example, a dedicated secure cryptoprocessor, such as a Trusted Platform Module (TPM), can be included in the device to perform the attestation. The secure cryptoprocessor includes one or more physical security features to prevent an attacker extracting cryptographic secrets that are stored in a sealed or secure storage medium of the cryptoprocessor. To attest the computer program, the secure cryptoprocessor may measure the executable code of the computer program and then use the measured value in combination with a secret stored in the secure storage medium to attest the authenticity of the computer program to another device. Additional hardware, such as secure cryptoprocessors, add additional cost to a device and, in the case some low processing power devices, such as programmable logic controllers (PLCs) for example, the additional hardware and processing capability cannot be included in the device at all. In some instances, some of the information from the secure storage medium may be undesirably released in order for the attestation to be performed. Furthermore, some attestation processes using a dedicated secure cryptoprocessor have the device requesting attestation of the computer program verify the authenticity of one or more certificates, issued during the attestation, with a third-party certification authority (CA).

Remote attestation of a computer program installed on a remote computing device by way of the methods described herein allows attestation to take place in instances even where the computing device has relatively low processing power. Furthermore, the methods described herein do not involve the release of any cryptographic secrets stored on the computing device thereby improving the security of the computer program and making it more difficult to compromise or mimic the computer program.

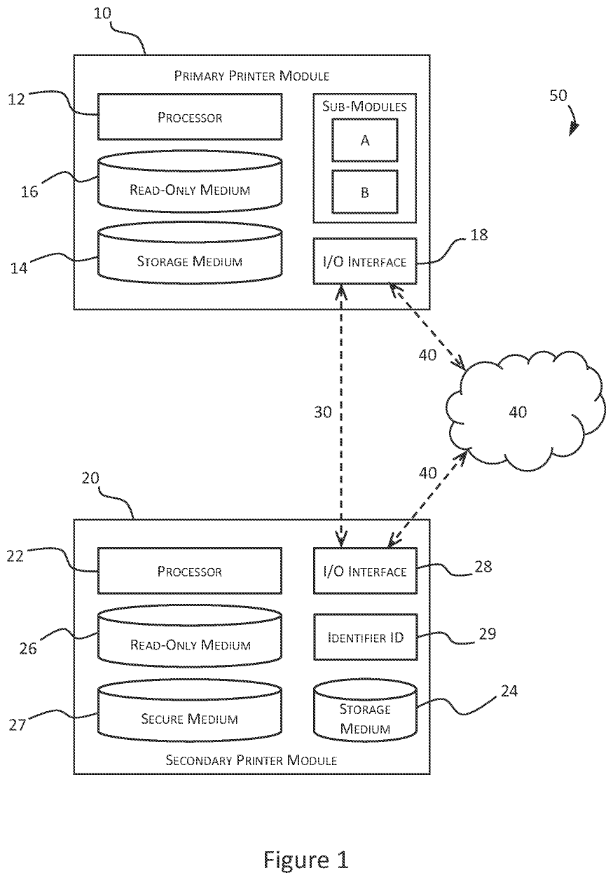

FIG. 1 illustrates an example computing system in which the methods described herein may be implemented. The computing system includes a first computing device and a second computing device. The computing system can include one or more other computing devices. In some examples, the first computing device may be considered a primary computing device, the master computing device, or a central controller. In some examples, the second computing device may be considered a secondary computing device or a puppet device. For instance, the second computing device may be controlled by a central controller.

In the example shown in FIG. 1, the computing system is a printing system 50 that comprises a plurality of modules. In one example, the printing system 50 may be an additive manufacturing system in which 3D objects are generated by solidifying selected portions of layers of build material. It will be understood that, although FIG. 1 illustrates a printing system 50, the computing system could be any suitable type of computing system in which the methods described herein may be implemented. The first computing device is a primary printer module 10. In certain examples, the primary printer module is the main printer component or the printer controller that centrally controls all, or some of, the functions of the printing system including any peripheral modules that interact with the primary printer module. In certain examples, the primary printer module 10 may be a computer, such as a PC, embedded in a printer. The second computing device is a secondary printer module 20. In one example, the secondary printer module 20 comprises a programmable logic controller (PLC). In certain instances, the secondary printer module 20 is a replaceable unit or an interchangeable unit that is connectable to the primary printer module 10 in some manner. In certain examples, the secondary printer module 20 is a cartridge that contains a consumable material for use with the printing system 50. For example, in an additive manufacturing system, the secondary printer module 20 may be a build material supply unit or a powder processing station having controllable valves that manage the flow of build material in the printing system 50. In some examples, the secondary printer module 20 is printer module that may be temporarily connected to the primary printer module 10 and that can be disconnected and exchanged for another similar or duplicate secondary printer module that performs similar functions.

The primary printer module 10 comprises a processor 12. The primary printer module 10 may comprise a non-transitory machine-readable storage medium 14, which may be encoded with instructions executable by the processor 12. The primary printer module 10 may comprise any number of additional processors and/or storage mediums to perform the desired functions. The primary printer module 10 comprises a non-transitory machine-readable read-only storage medium 16. The read-only storage medium 16 is encoded with machine-readable instructions that are executable by a processor. At least a portion of the executable instructions encoded on the read-only storage medium 16, when executed by a processor, provide for the basic functioning of the primary printer module 10. The executable instructions encoded on the read-only storage medium 16 may be described as firmware, i.e. they provide basic operating systems for the primary printer module 10, such as controlling the communication input/output hardware functions of the primary printer module 10. In some cases, additional firmware executable instructions may be encoded on the storage medium 14 and executed based on the firmware executable instructions encoded on the read-only storage medium 16. The executable instructions encoded on the read-only storage medium 16 may be executable by the processor 12. In certain examples, the read-only storage medium 16 may be integrated with a dedicated processor that executes the encoded instructions stored thereon. The dedicated processor may cooperate with the processor 12. The primary printer module 10 comprises an input/output interface 18, which provides communication connectivity with other computing devices, for example the secondary printer module 20. The interface 18 may be communicatively connected with one or more interfaces, for example, by way of communication cabling, or a wireless communication protocol. In one example, the interface 18 may operate using OPC Unified Architecture (OPC UA) communication protocol.

As illustrated in FIG. 1, the primary printer module 10 includes additional printing sub-modules A and B. In one example, where the printing system 50 is an additive manufacturing system in which three-dimensional (3D) objects can be generated, printing sub-module A could comprise a build material deposit system and printing sub-module B could comprise a build material fusing system.

The secondary printer module 20 comprises a processor 22 to execute encoded instructions. The secondary printer module 20 comprises a non-transitory machine-readable storage medium 24, which is encoded with machine-readable instructions executable by the processor 22. The storage medium 24 comprises at least one set of machine-readable executable instructions, i.e. a computer program that may be described as software, that may be the subject of a remote attestation process. The storage medium 24 may comprise one or more additional sets of executable instructions that, for instance, relate to the functioning of the secondary printer module 20 and/or printing system 50. The storage medium 24 may store data relating to the methods described herein. For instance, cryptographic secrets may be stored on the secure storage medium 27, such as permanently or temporarily storing any of the values and/or outputs of the blocks described herein. The secondary printer module 20 may comprise any number of additional processors and/or storage mediums to perform the desired functions.

The secondary printer module 20 comprises a non-transitory machine-readable read-only storage medium 26. The read-only storage medium 26 is encoded with machine-readable instructions that are executable by a processor. At least a portion of the executable instructions encoded on the read-only storage medium 26, when executed by a processor, provide for the basic functioning of the secondary printer module 20. The executable instructions encoded on the read-only storage medium 26 may be described as firmware, i.e. they provide basic operating systems for the secondary printer module, such as controlling the communication input/output hardware functions of the secondary printer module 20. In some instances, additional firmware executable instructions may be encoded on the storage medium 24 and executed based on the firmware executable instructions encoded on the read-only storage medium 26. It will be understood that the read-only storage medium 26 includes not only storage of the type that cannot be changed following manufacture, but also storage types that have limited re-write functionality without special equipment or having to endure very slow writing speeds. For example, the executable code can be written to the storage medium 26 on manufacture and a read-write attribute can subsequently be set to read-only so that the data cannot be overwritten. Examples include electrically erasable programmable read-only memory (EEPROM) or flash memory. The executable instructions encoded on the read-only storage medium 26 may be executable by the processor 22. In certain examples, the read-only storage medium 26 may be integrated with a dedicated processor that executes the encoded instructions stored thereon. For instance, the dedicated processor may execute the encoded instructions on the read-only storage medium when power is applied to the second printer module 20. The dedicated processor may cooperate with the processor 22. In some instances, the read-only storage medium 26 may be integrated with the storage medium 24. For example, the read-only storage medium 26 may form one partition of a single storage medium. It will be understood that, in some examples of the modules and in executing the methods described herein, the set of executable instructions that is to be the subject of a remote attestation process includes a set of executable instructions that is partially, or fully, stored on the read-only storage medium 26, for instance partially stored on the read-only storage medium when the secondary printer module 20 was originally manufactured or configured before distribution.

In some examples, the secondary printer module 20 comprises a non-transitory machine-readable secure storage medium 27, which may be encoded with machine-readable instructions executable by the processor 12. The secure storage medium 27 may securely store data such that the data cannot be accessed by a processor without the appropriate permissions. The secure storage medium 27 may store cryptographic secrets. For instance, the secure storage medium 27 may temporarily store any of the values and/or outputs of the blocks described herein. It will be understood that, in some instances, additional firmware executable instructions may be encoded on the secure storage medium 27 and executed based on the firmware executable instructions encoded on the read-only storage medium 26. In certain examples, the secure storage medium 27 may be integrated with a secure processor so that the secure storage medium 27 may be accessed independently of the remainder of the secondary printer module 20 to access the securely stored data. The secure processor may cooperate with the processor 12. In certain examples, the secure storage medium 27 and the storage medium 24 may be a single physical storage medium. For example, the secure storage medium 27 may be a partition of the single storage medium. It will be understood that, in some examples of the modules and in executing the methods described herein, the set of executable instructions that is to be the subject of a remote attestation process includes a set of executable instructions that is partially, or fully, stored on the secure storage medium 27.

The secondary printer module 20 comprises an input/output interface 28, which provides communications connectivity with other computing devices, for example the primary printer module 10. The interface 28 may be communicatively connected with one or more interfaces, for example, by way of communication cabling, or a wireless communication protocol. In one example, the interface 18 may operate using OPC Unified Architecture (OPC UA) communication protocol.

The secondary printer module 20 may be connected, or connectable, to the primary printer module 10 via a connection 30. The first computing device 10 and the secondary printer module 20 may transmit messages to one another through the connection 30. The connection 30 may be a physical connection or a wireless connection facilitated through the necessary architecture incorporated into the primary and secondary printer modules 10, 20. In some examples, the secondary printer module 20 is connected, or connectable, to the primary printer module 10 via a network connection 40, for example, or, in another example, via the internet. For example, the secondary printer module may be remotely connected to the primary printer module over a network, which would allow the features of the printing system to be located separately from each other, including the possibility of being separated by large distances. Where the printing system 50 operates in a user or customer environment, there is a risk that communications may be eavesdropped by an attacker. Thus, either of the primary printer module 10 or the secondary printer module 50 can be considered not secure against computer programs, stored on a storage medium within the modules 10, 20 being compromised.

In some examples, secondary printer module 20 may comprise a unique identifier (ID) 29. The unique identifier 29 may be stored in the read-only storage medium 26 or in a separate read-only storage medium that is provided specifically for storing the unique identifier 29. The unique identifier 29 data may be written to the selected read-only storage medium when the secondary printer module 20 is manufactured and protected from being modified. The unique identifier 29 data may be read as many times as necessary and may be publicly available, for instance via interface 28. For example, the unique identifier 29 may correspond to a serial number of the secondary printer module 20 that is physically marked on the secondary printer module 20. The unique identifier 29 may not be considered confidential or secret.

Although FIG. 1 illustrates one example of a computing system, various changes may be made to the system shown. For example, the system could include any number of each component in any suitable arrangement. It will be understood that computing systems can be provided in a wide variety of configurations and the arrangement illustrated in FIG. 1 does not limit the scope of this disclosure to any configuration and the features described herein may be utilized in any other system. It should be understood that the computing system may comprise all of, or some of, or one of, the units, modules, components, and/or systems described herein. For example, the primary printer module 10 may be supplied to a user separately from the secondary printer module 20. The primary printer module 10 may be to operate with a range of secondary printer modules. Similarly, the secondary printer module 20 may be to operate with a range of primary printer modules.

The use of a secure cryptoprocessor and/or the need to transmit secret information may be avoided by implementing any one of the methods described herein to remotely attest a set of executable instructions stored on a storage medium of a computing device. The methods, systems, and/or modules described herein reduce the risk that an attacker is able to compromise or mimic a computer program stored and/or executable on a secondary computing device, such as a PLC. For example, where the computing system is an additive manufacturing system, implementing the methods, systems, and/or modules described herein mitigate the possibility of an attacker compromising the functionality of a secondary printer module such as, for example, sabotaging valve control on a powder processing station so that excessive powder is used or discarded, thereby increasing the running cost of the additive manufacturing system and increasing waste.

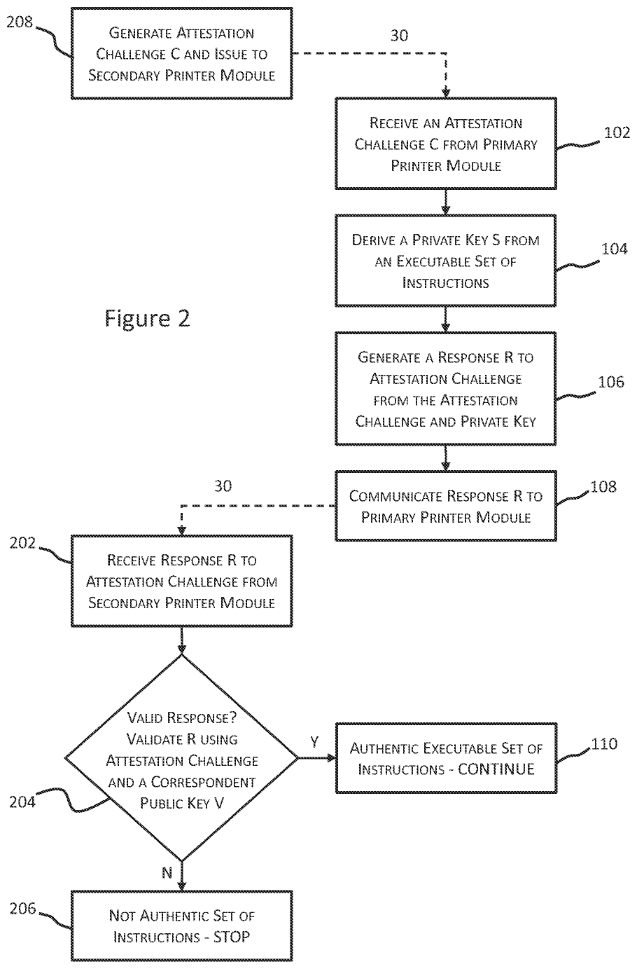

The methods may be implemented in the modules or systems described herein. Example first and second methods are illustrated in FIG. 2.

A first method comprises: receiving (at block 102), at a secondary printer module, an attestation challenge C generated by a primary printer module; deriving (at block 104), from a set of executable instructions encoded on a non-transitory machine-readable storage medium of the secondary printer module, a private key S; generating (at block 106), from the attestation challenge C and the private key S, a response R to the attestation challenge C; and communicating (at block 108) the response R to the primary printer module. As discussed further below, the first method may be carried out in any of the secondary printer modules described herein. The private key S is generated on receipt of the attestation challenge at the secondary printer module. The private key S is not stored permanently in any of the storage mediums of the second printer module. The private key S may be stored temporarily during the generation of the response R. Excepting certain cases where the primary printer module is being setup following a release of the set of executable instructions, as discussed further below, the private key S is generated within the secondary printer module and is not communicated outside of the secondary printer module. The generation of the response R may be described as digitally signing the attestation challenge in which a digital signature, created by encrypting the attestation challenge C (or a derivative thereof, such as a hash of the attestation challenge C) with the private key S, is included with the response.

A second method comprises: receiving (at block 202), at a primary printer module, a response R generated by a secondary printer module; validating (at block 204) the response R using an attestation challenge C and a public key V, the public key V corresponding to a private key S derived from a set of executable instructions encoded on a non-transitory machine-readable storage medium of the secondary printer module. Validation of the response may be described as checking the digital signature was generated by the corresponding private key S by decrypting the digital signature with the public key V and reviewing the decrypted value against the value of the attestation challenge C (or a derivative thereof).

If the response is valid then, at block 110, the set of executable instructions encoded on a non-transitory machine-readable storage medium of the secondary printer module is considered authentic. If the set of executable instructions is authentic then the activities originally desired of, or requested of, the secondary printer module can be allowed to continue. For instance, the set of executable instructions may then be executed on the secondary printer module or the secondary printer module may be permitted to communicate further with the primary printer module.

If the response is not valid then, at block 206, the set of executable instructions encoded on a non-transitory machine-readable storage medium of the secondary printer module is considered not authentic. If the set of executable instructions is not authentic then the activities originally desired of, or requested of, the secondary printer module can be stopped or prevented from occurring at all. For instance, further communication with the primary printer module by the secondary printer module may be prevented or the communication link severed. In some examples, the execution of the set of executable instructions by the secondary printer module may be prevented.

In certain examples, the second method comprises generating (at block 208) the attestation challenge C to be issued to the secondary printer module. The second method may comprise issuing the attestation challenge C to the secondary printer module. The second method may comprise the primary printer module generating the attestation challenge C and issuing the attestation challenge C to the secondary printer module. For example, the attestation challenge C may be communicated to the secondary printer module via the input/output interfaces as described herein. The attestation challenge C may be a random challenge, that is generating the attestation challenge C involves generating a random number. The random number should be a very large number so that the random number is very difficult for an attacker to guess and, when further manipulated in the first and second methods, contributes to the computationally intractability of any generated values and keys.

As indicated in FIG. 2, in certain examples the issuing of the attestation challenge C and the communicating of the response C may be through connection 30 as illustrated in FIG. 1. It will be understood that a network connection 40 or an internet connection may be used.

It will be understood that the methods illustrated in FIG. 2 may be carried out independently or considered together as one method. Thus, the response received at block 202 may be the response generated at block 106, which is then communicated at block 108. The public key V at block 204 may be correspond to the private key S derived at block 104. In certain examples, the public key V may have been derived and then stored within a primary printer module before the private key S is derived by the first method. As discussed further below, there are various possibilities as to how the public key V can be provided to the primary printer module.

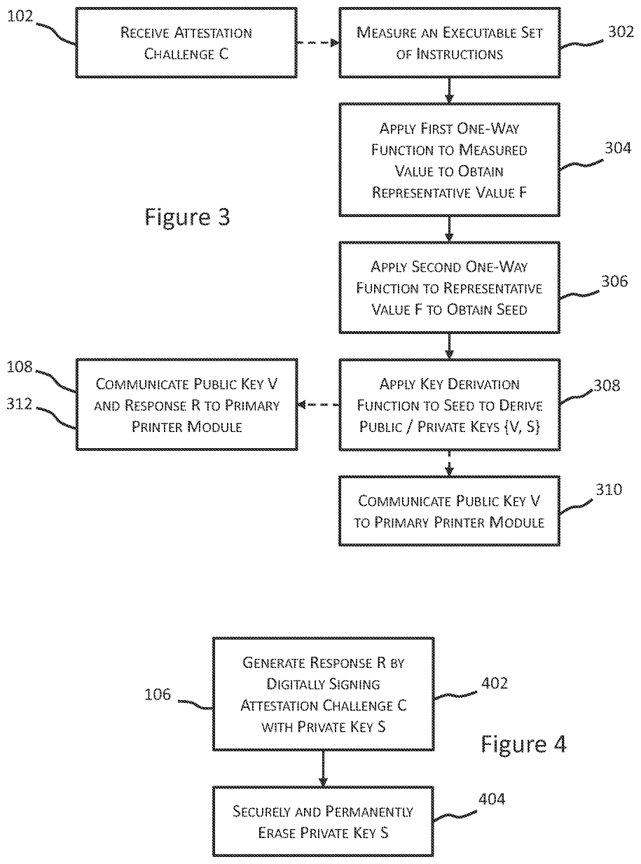

FIGS. 3 to 6 illustrate further example methods as described herein but that also include additional blocks.

FIG. 3 illustrates a method of generating a cryptographic asymmetric public/private key pair from a set of executable instructions, i.e. a computer program, such as that encoded on the storage medium of the secondary printer module.

Initially, in a method of generating a cryptographic asymmetric public/private key pair from a set of executable instructions, the set of executable instructions is measured to determine information about, or the state of, the set of executable instructions. An image of the stored executable code may be taken, i.e. an executable or binary image, that provides the measured value. For instance, the measured value may comprise the binary data in which the executable code has been stored. From the measured value, which is an arbitrary size, a fixed-size representative value F of the set of executable instructions is calculated using a one-way function. For example, a cryptographic hash or digest function of the measured value can be computed. This representative value F will always be the same for a set of executable instructions unless a modification is made to the instructions such as, for example, in the case of an updated version being released or, undesirably, if an attacker makes a change to the instructions to subvert the original intended purpose of the instructions. Any malicious change to the set of executable instructions, even if minor, can have a significant impact on the representative value F due to the avalanche effect when the one-way function is applied to the measured value.

The representative value F is then used as a seed to derive the public/private key pair using a Key Derivation Function (KDF). The seed may be calculated using a one-way function on the representative value F, such as hashing representative value F. A member of the Secure Hash Algorithm 2 (SHA-2) family of cryptographic hash functions may be used to derive the seed. In one example, a SHA-256 algorithm may be used such that:

seed=SHA256(F)

From the generated seed, the Key Derivation Function is used to generate the public key V (verification key) and the private key S (signature key):

{V,S}=KDF(seed)

Thus, where a SHA-256 algorithm is used to derive the seed, the private key s may be expressed as:

S=KDF(SHA256(F)

Any suitable Key Derivation Function that can be used to generate unique an asymmetric key pair from the representative value F, can be applied in the methods disclosed herein. For example, the RSA (Rivest-Shamir-Adleman) public/private key cryptography system may be used. It will be understood that there are many suitable public/private key cryptography systems that may be used to implement the methods disclosed herein.

The public key V can be retained for distribution outside of the secondary printer module or discarded if, as explained below, the public key V has been generated elsewhere and already supplied to the primary printer module.

The example method, shown in FIG. 3, comprises: at block 302, measuring a set of executable instructions that is to be remotely attested to provide a measured value; calculating, at block 304, by applying a first one-way function to the measured value, a representative value F of the set of executable instructions; calculating, at block 306, by applying a second one-way function to the representative value F, a seed; and deriving, at block 308, a private key S by a applying a Key Derivation Function to the seed. In some examples, block 306 comprises using a SHA-256 algorithm as the second one-way function that is applied to the seed. In certain examples, block 308 also involves deriving a public key V.

In certain examples, block 104 of the first method may follow the method described with respect to FIG. 3. For example, the set of executable instructions that is to be measured may be the set of executable instructions encoded on a non-transitory machine-readable storage medium of the secondary printer module in block 104 and, from measuring that set of executable instructions the private key S is derived thereby allowing the response R to be generated at block 106. Thus, as FIG. 3 illustrates, in certain examples, where a set of instructions is to be attested, block 302 may follow block 102.

As illustrated in FIG. 4, certain examples of the first method may follow block 402 at block 106. In block 402, the response R is generated by using the private key S to apply a digital signature to the attestation challenge C. In other words, the attestation challenge C is encrypted with the private key S using a signing algorithm. In some examples, the attestation challenge C may be itself hashed before the resulting hash value is encrypted with the private key S. The response R, generated, or signed, with the private key S may thus be expressed as:

R=signₛ(C)

Any suitable signing algorithm that is based on asymmetric keys, and for which there is a Key Derivation Function that can be used to generate unique an asymmetric key pair from the representative value F, can be applied in the methods disclosed herein. For example, and as noted above the RSA public/private key cryptography system may be used.

In some examples of the first method, and as also illustrated in FIG. 4, the method at block 404 comprises securely deleting the private key S from any of the storage mediums of the secondary printer module. For instance, the derived private key S may require temporary storage on one of the storage mediums so that the private key S can be used in the signing processes at block 106/block 402. Once the attestation challenge C has been signed, the private key S can be erased to reduce the risk of an attacker obtaining the private key S. The private key S may be securely and permanently erased so that no trace of the private key S remains in any of the storage mediums of the secondary printer module. For example, the private key S may be erased by writing random data over the portion of the storage medium on which the private key S was temporarily recorded.

The public key V can be supplied to the primary printer module in a number of different ways. In one example, the public key V can be derived from the set of executable instructions at the time the set of executable instructions is released. For example, when a new version of a computer program is released to users, the public key V can be derived at the same time and communicated to any primary printing device that requires the public key V. To derive the public key V, blocks 302 to 308 shown in FIG. 3 can be followed and then, at block 310, the derived public key V disseminated to the primary printing device by any suitable means. Blocks 302 to 308 can, for instance, be followed by any suitable computing device at the time the set of executable instructions is released provided that the public key is not released.

In another example, the public key V may be derived from the set of executable instructions encoded on a non-transitory machine-readable storage medium of a secondary printer module and then communicated to the primary printer module. For example, during an initialization process when the secondary printer module is connected to a primary printer module, the secondary printer module may communicate the public key V to the primary printer module. Blocks 302 to 308 could be followed, independently of the first method, to derive the public key V, which can then be communicated to the primary printer module at block 310. Alternatively, blocks 302 to 308 can be followed as part of block 104 and the derived public key V then communicated to the primary printer module. In some instances, and as FIG. 3 illustrates, the derived public key V may be communicated to the primary printer module at block 312 at the same time as response R in block 108. In certain examples, the public key V may be communicated only once to the primary printer module at block 310 or block 312. In some examples, the public key V may be deleted after derivation and communication to the primary printer module. In other examples, the public key V may be derived and then retained in one of the secondary printer module storage mediums to be available for communication, at block 310 or block 312, to a primary printer module as and when requested.

In some examples of the methods disclosed herein, the public key V may be communicated with, or wrapped in, a digital certificate that has been issued by a trusted certification authority (CA), which allows verification of the authenticity of the public key V using the certification authority's public key. This further protects the integrity of the public key V.

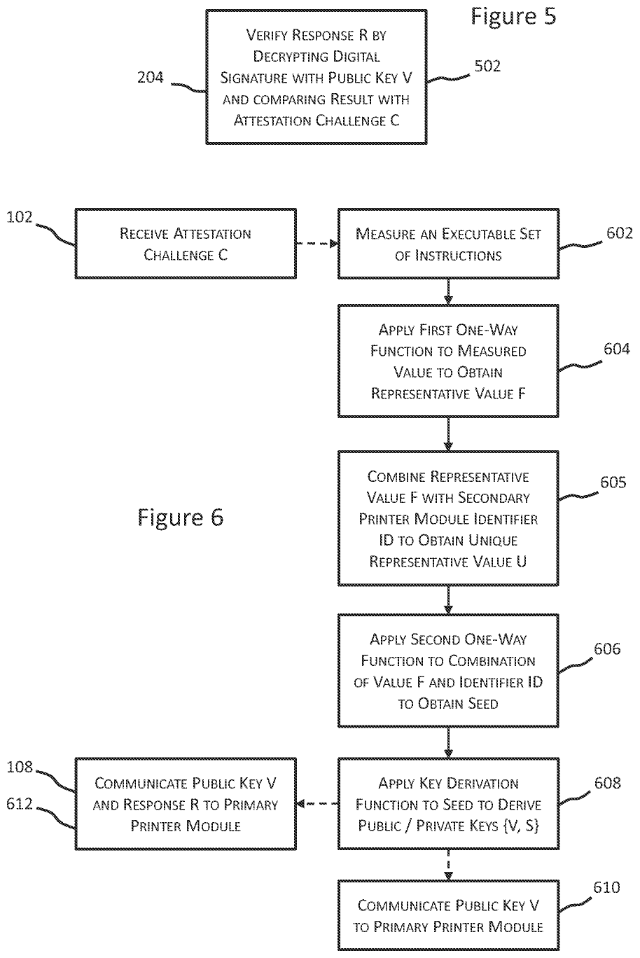

As illustrated in FIG. 5, certain examples of the second method may follow block 502 at block 204. In block 502, the digital signature (response R) is validated by using the public key V and the attestation challenge C, which is already known since, for instance, the attestation challenge was generated by the primary printer module. In one example, to verify the digital signature, the public key V is used to decrypt the digital signature and the resulting decrypted value is compared with the known attestation challenge C. If the response R cannot be decrypted, or if the decrypted value does not match the original attestation challenge C, then the set of executable instructions stored on a storage medium of the secondary printer module is not considered authentic. If the resulting decrypted value matches the original attestation challenge C, then the set of executable instructions stored on a storage medium of the secondary printer module is considered authentic. It will be understood that other validation algorithms may be employed to validate the digital signature. In examples where the attestation challenge C is itself hashed before the resulting hash value is encrypted with the private key S, the decrypted value may be compared with a hash of the known attestation challenge C. The verified response R may be expressed as:

verifyᵥ(signₛ(C))

FIG. 6 illustrates another method of generating a cryptographic asymmetric public/private key pair from a set of executable instructions, such as that encoded on the storage medium of the secondary printer module. In this example, an identifier of the secondary printer module, such as the identifier ID described above, is also used in the generation of the asymmetric key pair.

Initially, and as with the method described above, in this method of generating a cryptographic asymmetric public/private key pair from a set of executable instructions, the set of executable instructions is measured to determine information about, or the state of, the set of executable instructions. From the measured value, a representative value F of the set of executable instructions is calculated using a one-way function such as, for example, a cryptographic hash or digest function.

In this example, the representative value F is then combined with an identifier ID of the secondary printer module to provide a unique representative value U. Since the identifier ID of the secondary printer module is unique to the secondary printer module, the unique representative value U is also unique to the secondary printer module despite the set of executable instructions being the same as that stored on other secondary printer modules, even of the same model or type.

In certain examples, the unique representative value U is obtained from the direct sum of the representative value F and the identifier ID of the secondary printer module.

The unique representative value U is then used as a seed to derive the public/private key pair using a Key Derivation Function (KDF). In a manner similar to the method described above, the seed may be calculated using a one-way function on the unique representative value U, such as hashing representative value F.

Again, in an example where a member of the SHA-2 family, such as a SHA-256 algorithm, is used, the seed may be derived from a unique representative value U obtained from a direct sum of the representative value F and the identifier ID such that:

seed=SHA256(F⊕ID)

From the generated seed, the Key Derivation Function is used to generate the public key V (verification key), and the private key S (signature key):

{V,S}=KDF(seed)

Thus, where a SHA-256 algorithm is used to derive the seed, the private key s may be expressed as:

S=KDF(SHA256(F⊕ID)

As with the method described above, any suitable Key Derivation Function that can be used to generate unique an asymmetric key pair from the unique representative value U, can be applied in the methods disclosed herein. For example, the RSA public/private key cryptography system may be used.

In certain examples, block 104 of the first method may follow the method described with respect to FIG. 6. For example, the set of executable instructions that is to be measured may be the set of executable instructions encoded on a non-transitory machine-readable storage medium of the secondary printer module in block 104 and, from measuring that set of executable instructions and using an identifier ID of the secondary printer module, the private key S is derived thereby allowing the response R to be generated at block 106. Thus, as FIG. 6 illustrates, in certain examples, where the public key V is supplied to a primary printer module at the same time as the response R, block 602 may follow block 102.

The example method, shown in FIG. 6, comprises: at block 602, measuring a set of executable instructions that is to be remotely attested to provide a measured value; calculating, at block 604, by applying a first one-way function to the measured value, a representative value F of the set of executable instructions; combining, at block 605, the a representative value F with an identifier ID of the secondary printer module to obtain a unique representative value U; calculating, at block 606, by applying a second one-way function to the unique representative value U, a seed; and deriving, at block 308, a private key S by a applying a Key Derivation Function to the seed. In some examples, block 606 comprises using a SHA-256 algorithm as the second one-way function that is applied to the seed.

In example method shown in FIG. 6, block 608 also involves deriving a public key V. Since the unique representative value U is unique to each secondary printer module and set of executable instructions combination, the public key V needs to be communicated to a primary printer module to properly attest the set of executable instructions stored on the secondary printer module. In one example, the public key V may be communicated during an initialization process when the secondary printer module is connected to the primary printer module, the secondary printer module may communicate the public key V to the primary printer module. Blocks 602 to 608 could be followed, independently of the first method, to derive the public key V, which can then be communicated to the primary printer module at block 610. Alternatively, blocks 602 to 608 can be followed as part of block 104 and the derived public key V then communicated to the primary printer module. As FIG. 6 illustrates, the derived public key V may be communicated to the primary printer module at block 612 as part of block 108 and at the same time as response R. In certain examples, the public key V may be communicated only once to the primary printer module at block 610 or block 612. In some examples, the public key V may be deleted after derivation and communication to the primary printer module. In other examples, the public key V may be derived and then retained in one of the secondary printer module storage mediums to be available for communication, at block 610 or block 612, to a primary printer module as and when requested.

The example method(s) described herein may be performed in any of the example printer modules and/or printing systems and/or computing systems described herein and illustrated in any of the figures.

For example, the method(s) described above may be performed in the example primary printer module 10 and/or secondary printer module 20 illustrated in FIG. 1. In certain examples, the method(s) described above may be performed in a printing system, for example the printing system 50 also illustrated in FIG. 1. Once such printing system may be an additive manufacturing system. For instance, the processor(s) of the primary printer module 10 and/or secondary printer module 20 may carry out any of the processes or methods described herein or instruct they be carried out in the primary printer module 10 and/or secondary printer module 20. The processor(s) may execute the instructions in any suitable order, or simultaneously.

In one example, for the secondary printer module 20 illustrated in FIG. 1, a non-transitory machine-readable storage medium, such as read-only storage medium 26, comprises instructions which, when executed by a processor, such as processor 22, control the processor to: measure a value of a set of executable instructions encoded on a non-transitory machine-readable storage medium, such as storage medium 24; derive a private key from the measured value; generate a response to an attestation challenge issued by a primary printer module, the response generated from the attestation challenge using the private key; and communicate the response to the primary printer module. The non-transitory machine-readable storage medium 24 may be encoded with the other sets of instructions relating to the functioning of the printing system 50.

In one example, for the primary printer module 10 illustrated in FIG. 1, a non-transitory machine-readable storage medium, such as read-only storage medium 16, comprises instructions which, when executed by a processor, such as processor 12, control the processor to: generate an attestation challenge to be issued to a secondary printer module; validate a response from the secondary printer module using the attestation challenge and a public key, the public key corresponding to a private key derived from a measured value of a set of executable instructions encoded on a non-transitory machine-readable storage medium of the secondary printer module.

In certain examples, the attestation challenge is received at the secondary printer module 20 from the primary printer module 10, which also generated the attestation challenge. Furthermore, the response generated by the secondary printer module 10 is that which is received and validated by the primary printer module 10. Thus, the primary 10 and secondary 20 printer modules may cooperate to attest a set of executable instructions stored on a storage medium of the secondary printer module 20.

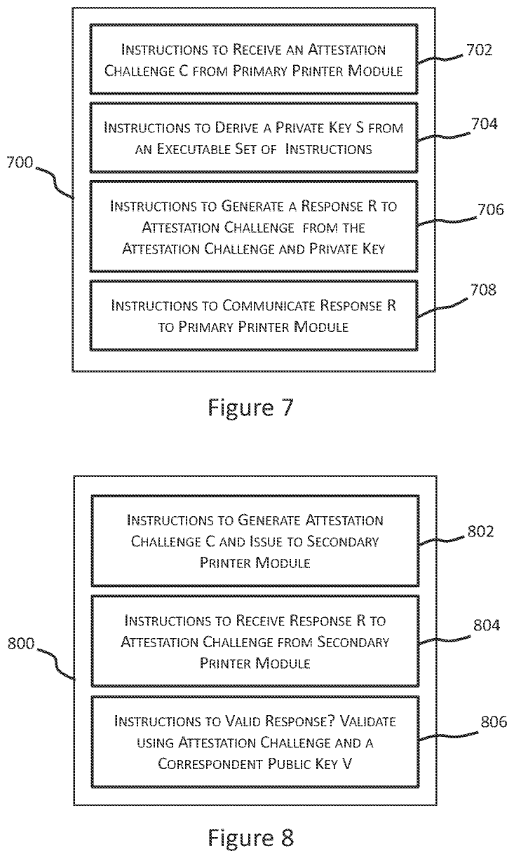

FIGS. 7 and 8 illustrate non-transitory machine-readable read-only storage mediums that may be encoded with instructions executable by a processor to perform the example method(s) described herein, for example the processor(s) of the example primary printer modules and/or secondary printer modules, as described herein. Some examples of non-transitory storage media are disks, thumb drives, memory cards and do not include propagated signals. The storage medium(s) may be supplied separately of the primary printer modules and/or secondary printer modules. Any of the example methods described herein may be encoded in machine readable form on a non-transitory machine-readable storage medium. For example, the example processes or methods above may be in the form of a computer program comprising computer program code. For example, the non-transitory machine-readable storage medium may be encoded with instructions for performing all, or any of, the blocks described herein. The processor(s) may retrieve and execute the encoded instructions and perform any of the blocks described herein or instruct another device, such as a build unit or powder processing station of an additive manufacturing system, to perform any of the blocks described herein. The processor may retrieve and execute encoded instructions and perform additional blocks relating to other functions of a printing system. The processor may execute the instructions such that they may be carried out in any suitable order, or simultaneously.

FIG. 7 illustrates one example of a non-transitory machine-readable read-only storage medium 700 encoded with instructions executable by a processor, in which the storage medium comprises: instructions to receive, at a secondary printer module, an attestation challenge generated by a primary printer module; instructions 704 to derive, from a set of executable instructions encoded on a non-transitory machine-readable storage medium of the secondary printer module, a private key; instructions 706 to generate, from the attestation challenge and the private key, a response to the attestation challenge; and instructions 708 to communicate the response to the primary printer module. The storage medium 700 may, for example, be provided to a secondary printer module, such as the secondary printer module 20 described with respect to FIG. 1.

FIG. 8 illustrates one example of a non-transitory machine-readable read-only storage medium 800 encoded with instructions executable by a processor, in which the storage medium comprises: instructions 802 to generate an attestation challenge to be issued to a secondary printer module; instructions 804 to receive, at a primary printer module, a response to the attestation challenge, the response generated by a secondary printer module; and instructions 806 to validate the response using the attestation challenge and a public key, the public key corresponding to a private key derived from a set of executable instructions encoded on a non-transitory machine-readable storage medium of the secondary printer module. The storage medium 800 may, for example, be provided to a primary printer module, such as the primary printer module 20 described with respect to FIG. 1.

It will be appreciated that the example blocks described herein may be implemented at various locations across a network. For example, a remote computer may store encoded instructions for performing an example of the methods described herein. A local or terminal computer may access the remote computer and access the encoded instructions. It will be appreciated that the example blocks may be implemented by a dedicated circuit, for example a DSP or a programmable logic array. It will be appreciated that the example blocks described herein may be implemented at various locations throughout a printing system. As described herein, the primary printer module and the secondary printer module may be combined into a single system and the blocks may be implemented in one location.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method comprising:
receiving, at a secondary printer module, an attestation challenge generated by a primary printer module;
deriving, from a set of executable instructions encoded on a non-transitory machine-readable storage medium of the secondary printer module, a private key;
generating, from the attestation challenge and the private key, a response to the attestation challenge; and
communicating the response to the primary printer module.

2. The method according to claim 1, wherein the method comprises deriving a public key from the set of executable instructions.

3. The method according to claim 1, wherein the method comprises generating the response by applying a digital signature to the attestation challenge with the private key.

4. The method according to claim 1, wherein the method comprises erasing the private key from a non-transitory machine-readable storage medium of the secondary printer module.

5. The method according to claim 1, wherein the method comprises:
measuring the set of executable instructions to provide a measured value;
calculating, by applying a first one-way function to the measured value, a representative value of the set of executable instructions;
calculating, by applying a second one-way function to the representative value, a seed; and
deriving, by applying a Key Derivation Function to the seed, the private key.

6. The method according to claim 5, wherein the method comprises calculating the seed by applying the second one-way function to a combination of the representative value F and an identifier of the secondary printer module.

7. The method according to claim 5, wherein the method comprises; deriving, by applying the Key Derivation Function to the seed, a public key; and communicating the public key to a primary printer module.

8. A method comprising:
receiving, at a primary printer module, a response to an attestation challenge, the response generated by a secondary printer module; and
validating the response using the attestation challenge and a public key, the public key corresponding to a private key derived from a set of executable instructions encoded on a non-transitory machine-readable storage medium of the secondary printer module.

9. The method according to claim 8, wherein the method comprises generating the attestation challenge and issuing the attestation challenge to the secondary printer module.

10. The method according to claim 8, wherein the method comprises, for an invalid response, severing communication with the secondary printer module or preventing execution of the set of executable instructions.

11. The method according to claim 8, wherein the response comprises a digital signature applied to the attestation challenge with the private key, and wherein the method comprises validating the response by decrypting the digital signature and comparing a decrypted value with the attestation challenge.

12. A secondary printer module comprising:
a non-transitory machine-readable storage medium encoded with a set of executable instructions;
a processor; and
a non-transitory machine-readable read-only storage medium comprising instructions which, when executed by the processor, control the processor to:
measure a value of the set of executable instructions;
derive a private key from the measured value;
generate a response to an attestation challenge issued by a primary printer module, the response generated from the attestation challenge using the private key; and
communicate the response to the primary printer module.

13. A primary printer module comprising:
a processor; and
a non-transitory machine-readable storage medium comprising instructions which, when executed by the processor, control the processor to:
generate an attestation challenge to be issued to a secondary printer module; and
validate a response from the secondary printer module using the attestation challenge and a public key, the public key corresponding to a private key derived from a measured value of a set of executable instructions encoded on a non-transitory machine-readable storage medium of the secondary printer module.

14. A non-transitory machine-readable storage medium comprising instructions executable by a processor, the storage medium comprising:
instructions to receive, at a secondary printer module, an attestation challenge generated by a primary printer module;
instructions to derive, from a set of executable instructions encoded on a non-transitory machine-readable storage medium of the secondary printer module, a private key;
instructions to generate, from the attestation challenge and the private key, a response to the attestation challenge; and
instructions to communicate the response to the primary printer module.

15. A non-transitory machine-readable storage medium comprising instructions executable by a processor, the storage medium comprising:
instructions to generate an attestation challenge to be issued to a secondary printer module;
instructions to receive, at a primary printer module, a response to the attestation challenge, the response generated by a secondary printer module; and
instructions to validate the response using the attestation challenge and a public key, the public key corresponding to a private key derived from a set of executable instructions encoded on a non-transitory machine-readable storage medium of the secondary printer module.
